(19) United States
(12) Patent Application Publication
(10) Pub. No.: US 2004/0159991 A1
(43) Pub. Date: Aug. 19, 2004

(54) Modular bearing system

(76) Inventors: Franz Josef Wolf, Bad Soden-Salmunster (DE); Otto Weber, Wolfsburg (DE); Kurt Kummel, Bensheim (DE); Volkmar Keck, Wolfsburg (DE); Freimut Galli, Wachtersbach (DE)

Correspondence Address: SCHIFF HARDIN, LLP, PATENT DEPARTMENT, 6600 SEARS TOWER, CHICAGO, IL, 60606-6473, US

(21) Appl. No.: 10/474,077

(22) PCT Filed: Apr. 3, 2002
(86) PCT No.: PCT/EP02/03686

(30) Foreign Application Priority Data
Apr. 3, 2001 (DE) 101 17 443.8
Apr. 3, 2001 (DE) 101 17 493.4
Apr. 3, 2001 (DE) 101 17 494.2

(51) Int. Cl. F16F 5/00

(52) U.S. Cl. 267/140.11

(57) ABSTRACT

The invention relates to a modular bearing system having a lid section on the load side and a bottom section on the buttress side. At least two parallel-connected functional units selected from amongst a plurality of functional units are releasably fixed between the lid section and the bottom section. Said functional units comprise at least one rubber-metal bearing element, an pneumatic bearing element, a hydraulic bearing element, a solid bearing element, a spring, a spring element, an annular core spring, a conical spring, a pneumatic spring, a damper and/or a pneumatic damper for damping and/or bearing a load that is to be supported by the lid section, especially in the form of a unit or running gear of a motor vehicle, relative to a bearing supporting the bottom section, especially in the form of a chassis or body structure of a motor vehicle, said units having a set and/or adjustable frequency, damping and/or amplitude. The invention also relates to the use of said system and to a method for regulating the frequency, damping and/or amplitude of said system.

The invention concerns a modular bearing system, the use of the same, as well as a method to adjust the frequency, damping and/or amplitude of the same.

In the prior art, many different bearings are known that comprise different damping and/or bearing characteristics. In particular in motor vehicle technology, the conception of new bearings is intensively dealt with. It is there a paramount task to minimize the transfer in particular of aggregate vibrations and structure-borne sound to the passenger area. Rubber-metal bearing elements with air damping have thereby emerged not only as absolutely advisable with regard to the damping properties, but rather also due to the good recycling possibility as well as the cost-effective production.

For example, from DE 4035375 in particular a damping bearing serving as an aggregate bearing for motor vehicles is known that, coupled in parallel between two rigid bearing connections, comprises a rubber elastic bearing and a pneumatic spring whose air chamber formed by a bellows is divided by a flow restrictor into two sub-chambers. The flow restrictor is thereby connected via a rod with one of the bearing connections, while the air chamber is contained by a rigid housing connected with the other bearing connection. The bellows forming the air chamber is provided with at least one upstroke valve, such that an automatic loading or inflation of the pneumatic spring ensues given relative motion between the bearing connections.

From DE 3139915, an air-damped rubber bearing is known with an upper and a lower fitting piece, a cylindrical rubber body between the fitting pieces that defines a changeable volume of an air chamber, and a piston-shaped rubber body whose shaft fits pressure-sealed into the cylindrical body and is stuck fast to the upper fitting piece. The piston-shaped body is thereby arranged in the air chamber in order to divide it into an upper and a lower air chamber. Via an opening, air is discharged from the upper and lower air chamber, or air is supplied to the air chamber. For this, a pressure membrane is provided that is associated with one or both chambers and reduces the size of the effective volume change to a specific size.

EP 1063446 A1 discloses an air damper, in particular for motor vehicle aggregate bearings, with two retained damping plates aligned coplanar to one another and movable at a variable separation relative to one another via a flexible membrane, that enclose between them a damping chamber. The membrane is thereby preferably fashioned as a roll membrane, and a restrictor channel is provided by one or both damping plates. This assembly enables adjustable and controllable damping capacity on small structural volumes without great effort.

The less environmentally friendly hydraulic dampers, as they are for example specified in DE 3836191 C1, have proven their worth in the past.

However, what is disadvantageous in the bearings known until now is the very limited, precisely specified use purpose. This requires of, for example, a motor vehicle producer a large inventory for different bearings, which is in turn connected with a high cost expenditure.

It is therefore the object of the present invention to provide a modular bearing system to overcome the above disadvantages, that can be assembled according to a building block principle depending on desired characteristics and available space. This enables in particular the motor vehicle producer to implement a plurality of different bearing and/or damping functions given less inventory. Furthermore, a method to overcome the above disadvantages, in particular to adjust the damping and/or bearing characteristics of such a modular bearing system, should be provided.

This object is inventively achieved via a modular bearing system with a load-side cover section and an abutment-side floor section, whereby at least two functional units selected from a plurality of functional units (comprising at least one rubber-metal bearing element, an air bearing element, a hydraulic bearing element, a solid bearing element, a spring, a spring element, a toroidal core spring, a cone spring, a pneumatic spring, a damper and/or an air damper to damp and/or bear a load to be supported by the cover section—in particular in the form of an aggregate or undercarriage of a motor vehicle—relative to a carrier carrying the floor section, in particular in the form of a chassis or car body structure of a motor vehicle, with adjusted and/or adjustable frequency, damping and/or amplitude in parallel coupling) can be detachably affixed between the cover section and the floor section.

It can thereby be provided that the cover section and/or the floor section is or, respectively, are at least in areas comprised by the load and/or the carrier, whereby preferably the floor section is at least in areas comprised by the carrier.

The invention can thereby be characterized in that the load and/or the carrier comprises or, respectively, comprise a hollow section, in particular in the form of two half-shells, whereby the upper half-shell preferably serves to enclose at least one functional unit, and the lower half-shell encloses at least one further functional unit, in particular the half shells comprise a central bore in which a central bolt can be introduced to detachably affix the functional units.

It is also proposed with the invention that at least one part of the cover section and/or at least one part of the floor section is interchangeably fashioned in adaptation to the number and/or the type of the selected functional units and/or the adjusted and/or adjustable frequency, damping and/or amplitude.

An embodiment of the invention is characterized by at least one supplementary functional unit that can be arranged between the cover section and the floor section, or outside of the cover section and of the floor section, and alternatively can be connected to the minimum two functional units between the cover section and the floor section.

A further embodiment is characterized by at least one sensor to recognize the damping and/or bearing characteristic.

Furthermore, the invention can be characterized by a control and/or regulating unit in effective connection with the functional units, the supplementary functional unit, the sensor, the load and/or the carrier.

Furthermore, an embodiment of the invention is characterized by a toroidal core spring, cone spring and/or a spring element, preferably fashioned from an elastomer and comprised in its inner cavities and/or channels as a first functional unit (in particular arranged on the load side) and from at least one dynamic air damper as a second functional unit (in particular arranged on the abutment side).

It can thereby be provided that the air damper comprises at least one damper chamber, in particular a dynamic air chamber that is defined on the load side by the toroidal core spring, the cone spring and/or the spring element, either directly or via a part of the cover section and/or floor section.

Furthermore, it,is proposed with the invention that the air damper substantially introduces no operative effective spring components into the bearing characteristic line of the toroidal core spring.

It can also be inventively provided that the air damper comprises an axially movable membrane plate (firmly connected with at least one part of the cover section) in which at least one throttling port is provided that is open on both sides, and at least one damper chamber that is partially defined by a membrane (in particular roll membrane) firmly connected with the membrane plate and/or by the membrane plate itself, whereby the membrane plate is aligned coplanar to an axially opposite counter plate of the floor section.

Furthermore, it can be provided that the air damper comprises a damper chamber on the load side (with regard to the membrane plate).

It is likewise proposed with the invention that the floor section comprises an attachment part that is attached to the carrier to jam [sic] the membrane, and comprises a fitting dimensioned recess for unhindered passage of the membrane plate.

In a further embodiment, it is provided that the air damper comprises two damper chambers, whereby a load-side damper chamber is separated from an abutment-side damper chamber via the membrane plate and the membrane connected with it.

An embodiment thereby features that the floor section comprises a covering cap (preferably that can be detachably connected with the carrier, in particular fashioned cup-shaped) and the abutment-side damper chamber is bounded by the covering cap, whereby preferably each damper chamber is sealed via surrounding jamming of the membrane connected with the membrane plate between the carrier and covering cap.

Furthermore, it can be inventively provided that the membrane plate can be detachably connected (in particular via screwing) with the cover section and/or floor section.

A further embodiment is characterized by a nozzle disc with at least one throttling port by which the damper chamber is bounded on the abutment side, whereby the nozzle disc can preferably be detachably connected with the cover section and/or floor section.

It can thereby be provided that the cone spring comprises at least one abutment-side spring-projection and the nozzle disc comprises at least one abutment-side depression complementary to the spring projection, in particular in the region of the throttling port.

Foam material can inventively be provided in at least one damper chamber, preferably in the form of a foam material layer on the membrane plate and/or the counter plate and/or the covering cap or the nozzle disc.

A further embodiment is characterized by at least one air bearing as a third functional unit on the abutment side of the air damper.

Furthermore, it can thereby be provided that the air bearing comprises at least one static bearing chamber that is preferably bounded on the abutment side by the nozzle disc.

For this, at least one cushioning disc is inventively proposed with at least one throttling port by which two bearing chambers are separated from one another, whereby the cushioning disc can preferably be detachably connected with the floor section or is firmly integrated into the floor section.

Furthermore, proposed with the invention is an air connection (in particular with a valve) to a bearing chamber, whereby the air connection is preferably integrated into an interchangeable part of the floor section.

Furthermore, the invention can be characterized by a first sensor to recognize the height of the air column in an air damper and/or air bearing, and/or a second sensor to recognize the pressure in an air damper and/or air bearing, whereby the first and/or second sensor is preferably effectively connected with the control and/or regulation unit.

It can be provided for this that at least one throttling port can be varied or, respectively, adjusted (preferably continuously) via the control and/or regulation unit.

It is also inventively proposed that the separation between the load and the carrier is adjustable, in particular via the control and/or regulation unit, preferably via at least one element of the cover section and/or floor section that can be telescoped, inflated, swung out, rotated out and/or extended.

A further embodiment is characterized in that modules of the bearing system, in particular at least one part of the cover section, at least one part of the floor section, and at least one part of each functional unit comprises or, respectively, comprise at least one marking to facilitate an assembly.

Furthermore, it can thereby be provided that the marking can be taken from a target use purpose.

Further proposed is the use of the inventive modular bearing system in vehicle technology, in particular motor vehicle technology, in particular for bearing of aggregates such as an internal combustion engine and/or a wheel suspension.

The object concerning the method to adjust the amplitude, damping and/or frequency behavior of a modular bearing system is achieved in that the method comprises the steps:

Determination of the desired amplitude, damping and/or frequency behavior of the bearing system;

Selection of at least four modules, in particular in the form of a load-side cover section, an abutment-side floor section, and two functional units (in particular that can be detachably affixed coupled in parallel between the cover section and the floor section) such as a rubber-metal bearing element, an air bearing element, a hydraulic bearing element, a solid bearing element, a spring, a spring element, a toroidal core spring, a cone spring, an air spring, a damper and/or an air damper with adjusted and/or adjustable damping, frequency and/or amplitude;

assembly of the module, in particular by means of at least one screw connection, riveted connection, welded connection and/or adhesive connection.

It can thereby be provided that the selection is facilitated by at least one marking, in particular for identification of a target use purpose and/or the adjusted damping, frequency and/or amplitude that is exhibited by the modules. The inventive method can furthermore advantageously comprise the additional adjustment and/or adaptation of the damping, frequency and/or amplitude of at least one module, in particular during the operation of the bearing system.

A further embodiment of the method advantageously provides that the adjustment and/or the adaptation of the damping, frequency and/or amplitude of the module comprises

the adjustment, in particular of the geometry and/or of at least one flow-through property, at least one throttling port between two air chambers (preferably comprised by an air damper and/or a neumatic spring),

the adjustment, preferably by means of a valve, of an air pressure within at least one air chamber, and/or

the adjustment of the volume of at least one air chamber, preferably by means of a linked the air chamber [sic] with a further air volume, in particular by means of a valve arranged between the air chamber and the air volume and/or an adjustment of the geometry of the air chamber,

preferably by means of a control and/or regulation unit and/or dependent on at least one measurement value provided by a sensor (preferably effectively connected to the control and/or regulation unit), such as an air column, a load property (preferably the weight of the load), a vibration frequency and/or a pressure.

Finally, it can be advantageously provided in the method that at least one module from the bearing system is removed and/or exchanged to adjust the damping, frequency and/or amplitude behavior.

The invention thus forms the basis of the surprising realization that a bearing can be modularly assembled, whereby the different components are both matched to and coordinated for different use purposes. In other words, it means that a complex coordination method between different functional units of an inventive modular bearing system is not necessary, since the corresponding modules are respectively standard parts whose characteristics are already documented by the producer.

If, for example, an auto manufacturer wishes to use a solid bearing with a toroidal core spring and an air damper for specific damping and bearing characteristics, he selects, using a marking belonging to the desired characteristics, from a module kit a specific cover section, a specific floor section, a specific toroidal core spring, and a specific air damper and then assembles the modules so to say on site, in that he or she, for example, inserts the toroidal core spring into the cover section and the air damper into the floor section in order to then connect both sections with one another, for example via a screw.

However, even a refitting of a modular bearing system is inventively possible. If, for example, the above-specified combination of a toroidal core spring and an air damper is to be supplemented by an air bearing, only the floor section is to be exchanged. The new floor section could then, for example, comprise a cushioning disc with a throttling port to connect a dynamic air chamber functioning as an air damper, with a static air chamber functioning as an air bearing.

The inventive modular bearing system thus opens up a wide plurality of use possibilities according to the type of building block system.

Via the inventive modular bearing system, the production costs and the own weight of a bearing can be further reduced in that, for example, a floor section fashioned completely separate from a carrier (such as a car body structure of a motor vehicle) is replaced by a floor section that is at least in sections already supplied by the carrier. The analogous is true in connection with the cover section and a load attached to it, such as an aggregate. For this, it is hereby enabled that a motor vehicle producer already makes arrangements in the production of a car body structure that enables a later trouble-free connection to the bearing system, which leads to a further time savings in the final assembly.

Advantageously, a control and/or regulation unit is also inventively provided via which an amplitude, damping and/or frequency tuning (in particular for shifting the eigenfrequency of the modular bearing system relative to the excitation frequency, for example given excitation of a wheel suspension or a shock excitation) can be implemented independently of the geometric measurements of the module used, for example via adjustment of throttling ports between two air chambers or the impact of an air chamber with actuating pressure or the like.

Further features and advantages of the invention arise from the subsequent specification, in which embodiments of the invention are individually explained using schematic drawings. Thereby shown are:

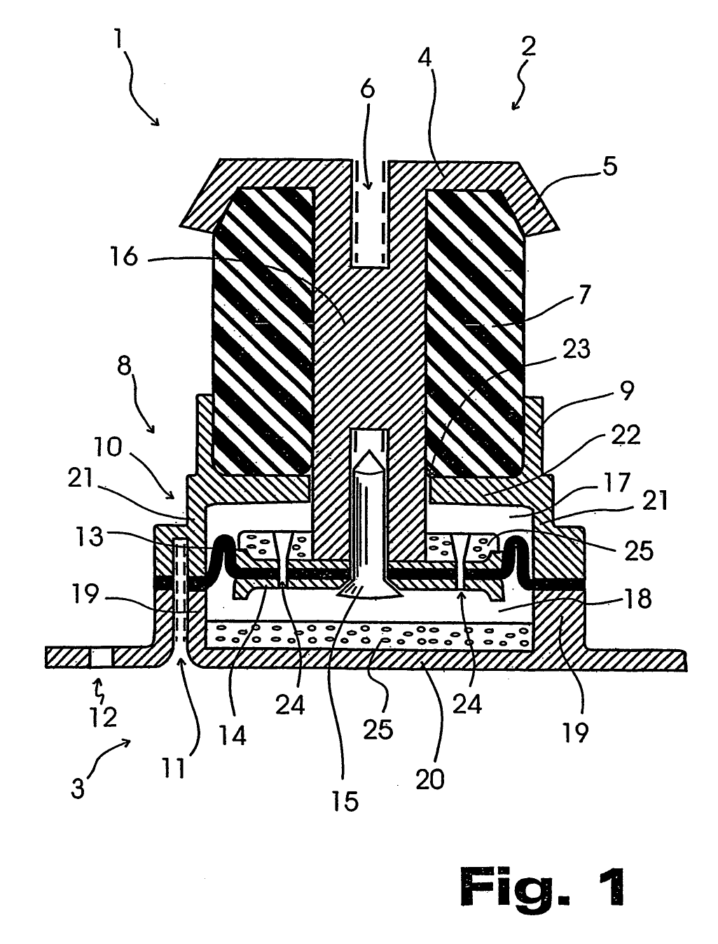

FIG. 1 a sectional view through a first inventive bearing system;

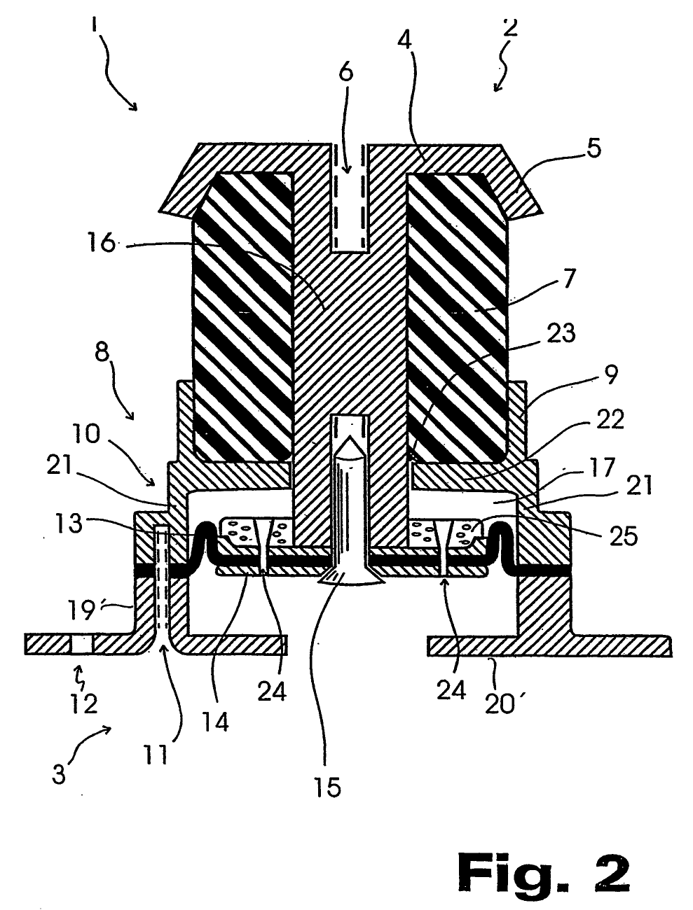

FIG. 2 a sectional view through a second inventive bearing system;

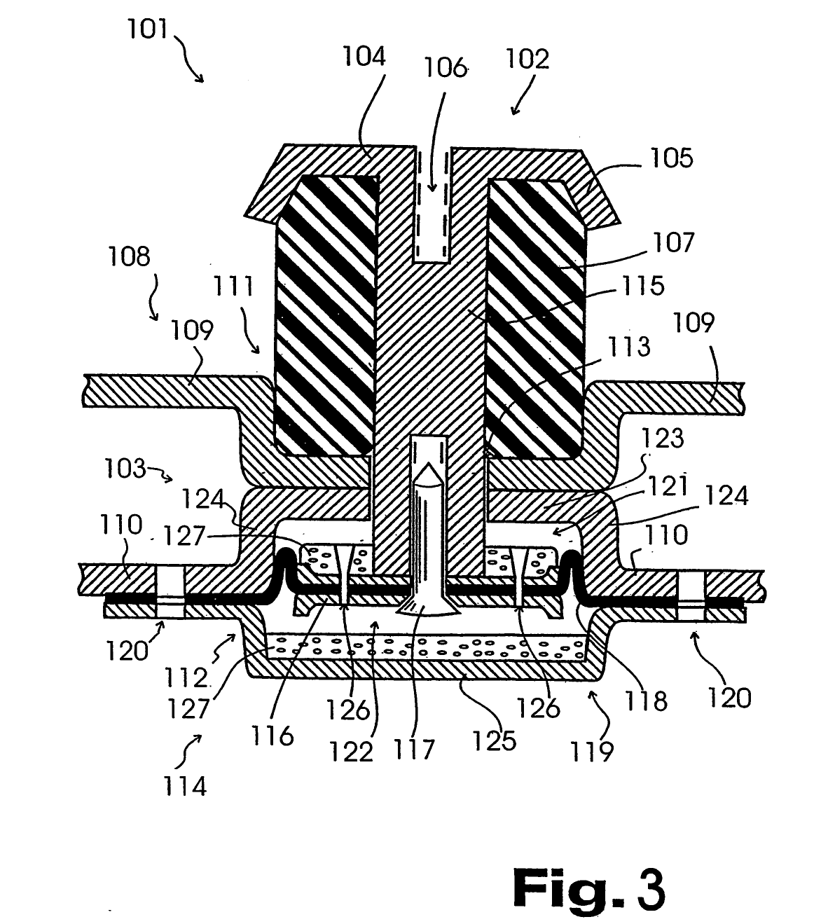

FIG. 3 a sectional view through a third inventive bearing system;

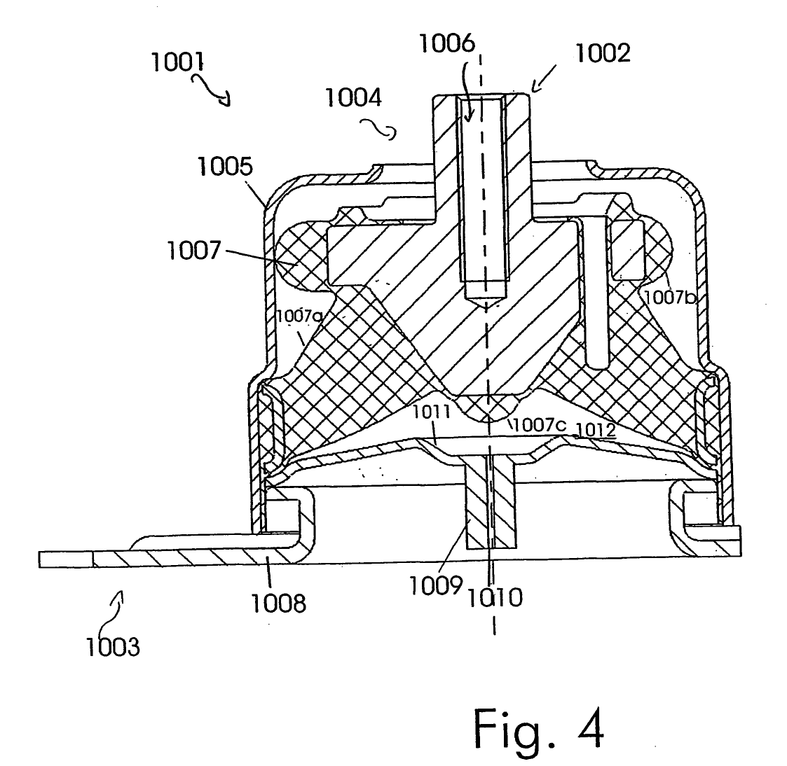

FIG. 4 a sectional view through a fourth inventive bearing system;

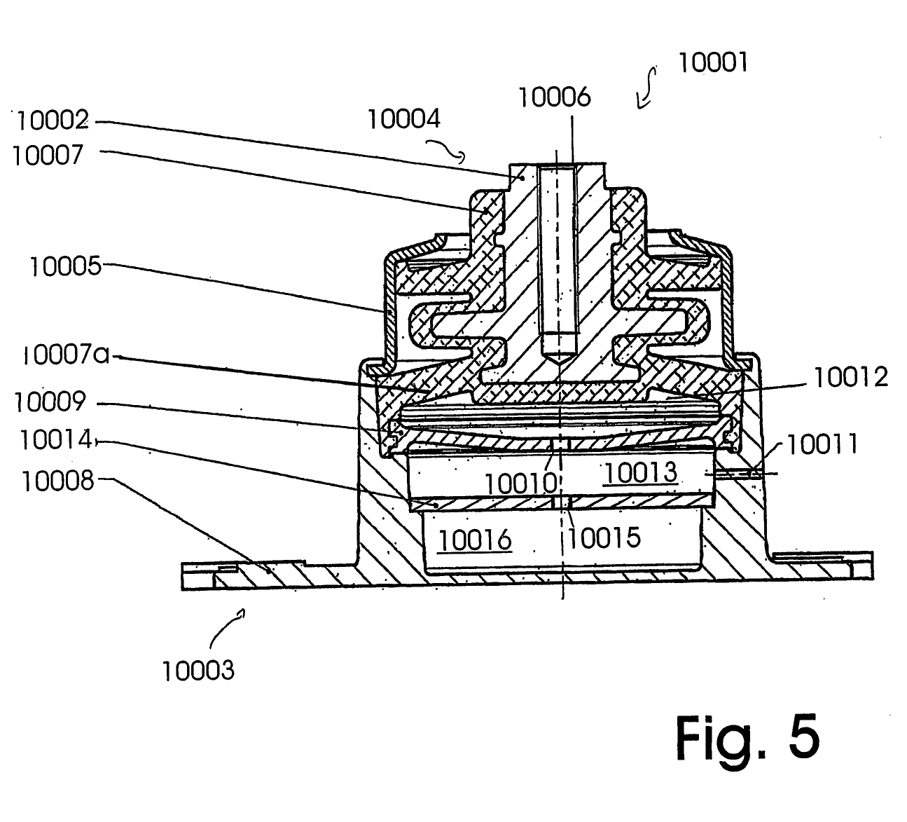

FIG. 5 a sectional view through a fifth inventive bearing system; and

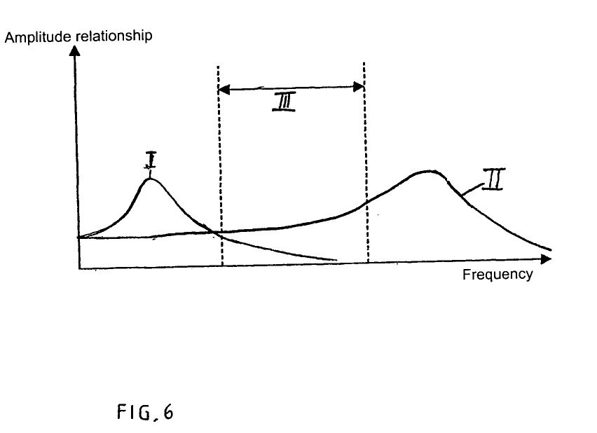

FIG. 6 a graphic application of the amplitude relationship of load amplitude to excited amplitude over the frequency.

FIG. 1 shows a first exemplary embodiment of an inventive bearing system in the form of a solid bearing 1 in a partially cut side view. The solid bearing 1 thereby comprises a load connection 2 as well as an abutment connection 3 axially opposite this. The load connection 2, with a disc-shaped region surrounded by a skirt 5 to protect from dirt and mechanical damage, forms a cover section 4 and is aligned parallel to the abutment connection 3 that is associated with a floor section. A threaded bore 6 arranged centrally in the cover section 4 serves for attaching a load (not shown). The cover section 4 lies on a toroidal core spring 7 that is supported on a damping housing that is likewise associated with the floor section. To stabilize the toroidal core spring 7 in a radial direction, on the damper housing 8 a collar 9 is provided running circumferentially that, for this, cooperates with the skirt 5. The damper housing 8 comprises an upper housing part 10 as well as the abutment connection 3, on or in which a cuplike depression is fashioned that serves as a lower air damper housing part. Both housing parts 3, 10 are connected with one another via bolts and threaded bores 11 (not separately shown in FIG. 1). The threaded bores 11 are circumferentially distributed around the cylindrical damper housing 8 such that they span an angle of 60 degrees to one another. For attachment of the solid bearing 1 to a vehicle web (not shown) connection bores 12 are provided in the abutment connection 3.

A roll membrane 13 is jammed gas-tight between the upper housing part 10 and the abutment connection 3, whereby the roll membrane 13 is connected gas-tight with a membrane plate 14 that in turn is screwed by means of an attachment screw 15 to a connection section 16 of the cover section 4. The gas-tight connection of the roll membrane 13 to the membrane plate 14 can be effected in any manner, for example via glue or via adhesion means such as vulcanization or the like. The roll membrane 13 and the membrane plate 14 divide the inside of the overall abutment-side damper housing 8 into a load-side damper chamber 17 as well as into an abutment-side damper chamber 18. The abutment-side damper chamber 18 is thus bounded by the membrane plate 14 of the roll membrane 13 as well as by two sidewalls 19 and a floor wall 20 of the abutment connection 3, whereby the floor wall 20 runs coplanar to the membrane plate 14. The load-side damper chamber 17 is bounded by the membrane plate 14, the roll membrane 13, a cover wall 22 aligned coplanar to the membrane plate 14, and side walls 21 of the upper housing part 10. To pass the connection section 16 (that extends from the load connection 2 through a tube-shaped connecting opening of the toroidal core spring 7 to the membrane plate 14), a housing opening 23 is provided in the cover wall 22. In contrast to the connection section 16, this is not sealed, such that air (in particular given the unloaded state of the toroidal core spring 7) can escape from the load-side damper chamber 17 via the housing opening 23. However, via the acceptance of a static load on the load connection 2, the toroidal core spring 7 is pressed firmly against the upper housing part 10, whereby it elastically deforms and in this manner terminates gas-tight the upper damper chamber 17. In the membrane plate 14, throttling ports 24 are provided that connect the damper chambers 17, 18 interconnected with one another. The load connection 2 is connected both with the toroidal core spring 7 and with the membrane plate 14 that forms a part of the air damper that further comprises the damper chambers 17, 18, the roll membrane 13, and the housing parts 3, 10. The toroidal core spring 7 is thus arranged coupled in parallel to the dynamic air damper that merely effects damping and effects no substantial changes in the characteristic line of the toroidal core spring 7, at least as long as the amplitudes remain in the normal operative range.

FIG. 1 shows the solid bearing 1 after the acceptance of a static load, whereby the display of the load (for example a vehicle aggregate) was dispensed with for reasons of clarity. In this state, the membrane plate 14 is approximately equally distant from each counter plate 20, 22 of the damper housing 8 fashioned coplanar to it. Given a dynamic load, the membrane plate 14 is, for example, shifted to the floor wall 20, such that the volume of the abutment-side damper chamber 18 is reduced and the air located within is compressed. Simultaneously, the load-side damper chamber 17 relaxes, such that due to the pressure difference air flows from the abutment-side damper chamber 18 through the throttling ports 24 into the load-side damper chamber 17. The kinetic energy generated by the motion of the membrane plate 14 is thereby at least partially accepted by the dynamic air damper. The energy so dissipated is not delivered to the load connection 2. This would be possible merely via an elastic deformation of the roll membrane 13 as well as a suitable geometry of the damper housing 8, however given the axial motion the membrane plate 14 is in no way elastically deformed, but rather due to its preformed roll folds it wanders rolling up and down. A swelling behavior of the roll membrane 13, in the form that this is inflated like a balloon by the pressure increase in a damper chamber 17, 18 under elastic deformation, can be prevented by a suitable material selection in the fabrication of the roll membrane 13 as well as a suitable geometry of the damper housing 8. The roll membrane 13 is thus comprised of an elastomer (that, under the respectively present conditions can not function as a swell spring due to its stiffness) or of a material that in no way exhibits elastic properties, but rather is merely gas-tight. Given the load swinging back, the previously specified event is reversed. The load-side damper chamber 17 is no longer compressed, while the abutment-side damper chamber 18 is relaxed.

It is to be noted at this point that the FIG. 1 in no manner reproduced the distances that are to be followed in the design of a solid bearing, for example for a use in a motor vehicle. For example, to damp a coupled dynamic load of a passenger vehicle aggregate, the damper chamber [sic] 17, 18 comprise a diameter of approximately 80 mm, whereby the membrane plate 14 is held in the unstressed state at a separation of approximately 2 mm to 5 mm from the surface of the respective counter plate 20, 22.

The damper shown in FIG. 1 is designed for amplitudes in the normal range of approximately 2 mm to 5 mm. In this normal design, in order to be able to also dynamically, softly damp larger overload shock amplitudes, foam material layers 25 are provided between the membrane plate 14 and its coplanar counter plates 20, 22. In the webwork of the present invention, the membrane plate 13 can also be provided on both sides with a foam material layer 25, and moreover each coplanar counter plate 20, 22 can comprise an additional foam material layer 25. As is indicated in FIG. 1, a foam material with closed pores was selected for the coating 25. This is characterized by a particularly high degree of damping, such that amplitudes that exceed the free-swinging range of the membrane plate 14 can also be effectively damped.

The modularity of the bearing system specified with regard to FIG. 1 is, for example, visible in that a release of the bolts from the threaded bores 11, subsequent exchange of the part of the floor section that is formed by the walls 19 and 20 with another new part of the floor section (such as it, for example, is shown in FIG. 2 with side walls 19′ and a floor wall 20′ opening downwards), and subsequent affixing of the new part via air connections in the threaded bores 11 already leads thereunto that only one dynamic damper chamber 17 remains that is then in contact with the atmosphere via its throttling ports 24. FIG. 2 thus illustrates a second inventive modular bearing system that substantially comprises the same modules as the bearing system according to FIG. 1, however comprises a function that differentiates it from the bearing system according to FIG. 1.

The third modular bearing system according to the invention in FIG. 3 differentiates itself from the bearing system according to figure substantially in that the floor section is partially provided by a chassis carrier 108. The bearing system of FIG. 3 is thus obtained again from the bearing system of FIG. 1 via exchange of a part of the floor section, as arises from the following detailed specification.

The solid bearing 101 according to FIG. 3 comprises a load connection 102 as well as an abutment connection 103 axially opposite the load connection 102. The load connection 102, with a disc-shaped area circumferentially bounded by a skirt 105, belongs to a cover section 104, whereby the skirt 105 is provided to protect the solid bearing 101 from dirt and mechanical damage. For attachment of a load (not shown), a central connection bore 106 with inner threading is provided in the load connection 102. The load connection 102 lies on a toroidal core spring 107 that is made of an elastomer and on which an abutment connection 103 associated with a floor section is supported for elastic load suspension. The abutment connection 103 is thereby simultaneously an integral component of a chassis carrier 108. The chassis carrier 108 shown in FIG. 3 is comprised of a hollow section of which, in the sectional view, an upper carrier web 109 as well as a lower carrier web 110 are visible. To fashion the abutment connection 103, the upper carrier web 109 and the lower carrier web 110 taper to one another, whereby they fashion a load-side depression 111 as well as an abutment-side depression 112 in the chassis carrier 108. The depressions 111, 112 comprise in a plan view (not shown) a circular contour with a central permeation opening 113. The load-side depression 111, together with the skirt 105, effects a stabilization of the cylindrical toroidal core spring 107 in a radial direction. The abutment-side depression 112 forms the housing of an air damper 114 specified in the following.

The toroidal core spring 107 comprises internally a central tube-shaped recess, via which a connection section 115 extends from the load connection 102 through the passage opening 113 to a membrane plate 116. The membrane plate 116 is firmly connected via an attachment screw 117 with the connection section 115, and thus with the load connection 102. Furthermore, it comprises a roll membrane 118 that is connected gas-tight with the membrane plate 116 via adhesion means, for example via vulcanization or by means of adhesives suitable for this. To circumferentially jam the roll membrane 118, a cage-like covering cap 119 is provided that is firmly mounted to the lower carrier web 110 with the aid of attachment screws (not shown) in threaded bores 120. Via this arrangement, a load-side damper chamber 121 as well as an abutment-side damper chamber 122 is [sic] defined that are separated from one another via the membrane plate 116 as well as via the roll membrane 118. The load-side damper chamber 121 is furthermore bounded by the outer surfaces of the abutment-side depression 112 of the chassis carrier 108, that for this comprise a chassis counter plate 123 fashioned coplanar to the membrane plate 116 as well as side walls 124. In order to prevent the escape of air through the permeation opening 113 in the chassis counter plate 123, the toroidal core spring 107 is fashioned such that, due to the elastic deformation as a result of the static load suspension, it is pressed against the abutment connection 103 and against the connection section 115, and thus seals the load-side damper chamber 121. The abutment-side damper chamber 122 likewise comprises a cover counter plate 125 fashioned coplanar to the membrane plate 116. In both sides of the membrane plate 116, open throttling ports 126 are provided that connect the damper chambers 121, 122 interconnected with one another. Furthermore, foam material 127 can be arranged in the damper chambers 121, 122.

The bearing system specified with reference to FIG. 3 works in principle exactly like the bearing system specified with reference to FIG. 1. Effectively, the aforementioned bearing systems differentiate from one another exclusively in their assembly or, respectively, construction on the carrier or, respectively, chassis carrier. The embodiment according to FIG. 3 is thereby particularly advantageous due to the saving of floor section parts.

The modular bearing system shown in FIG. 3 is also, for example, varied further in that the covering cap 119 that is a component of the floor section is replaced by a plate-shaped as well as annular attachment part (not shown) with threaded bores in the area of the threaded bore 120 of FIG. 3, such that only the load-side damper chamber 121 remains that is then connected with the atmosphere via the throttling ports 126.

The fourth modular bearing system of the invention shown in FIG. 4 fundamentally differentiates itself from those of FIGS. 1 through 3. In this bearing system is likewise a solid bearing 1001 with a load connection 1002 and an abutment connection 1003, whereby the load connection 1002, together with a housing part 1005, forms a cover section 1004, and the abutment connection 1003 is a component of a floor section. In the load connection 1002, a threaded bore 1006 is provided in a known manner, and the load connection 1002 carries a cone spring 1007 with spring struts 1007a, spring projections 1007b, and a central spring projection 1007c on the abutment-side end. However, the load connection 1002 does not extend through the cone spring 1007. Coupled in parallel to the cone spring 1007, a damper chamber 1012 is arranged that on the load side is directly bounded by the cone spring 1007 and directly bounded on the abutment side by a nozzle disc 1009. The nozzle disc 1009 is provided with a throttling port 1010 to connect with the external atmosphere, whereby the throttling port 1010 is arranged in the region of a depression 1011 that is provided complementary to the spring projection 1007c. The nozzle disc 1009 thus limits the maximal deformation of the cone spring 1007.

Due to the special geometric design of the cone spring 1007 in the solid bearing 1001, a membrane can be foregone since the cone spring 1007 is already elastically deformable, such that the damper chamber 1012 is a dynamic air chamber, meaning a chamber with varying volume.

The modular bearing system shown in FIG. 4 would, for example, be changed simply by exchanging a flange 1008 (belonging to the floor section) to connect to a carrier (not shown) with a closed cap, such that an air bearing is additionally arranged parallel to the solid bearing 1001 and the damper chamber 1012, and in fact bounded by the nozzle disc 1009 and the cap.

The fifth modular bearing system of the invention, shown in FIG. 5, is substantially a last specified bearing system, comprising in parallel coupling a spring element, a damper and a bearing. In detail, the inventive modular bearing system of FIG. 5 also again shows a solid bearing 10001 with a load connection 10002 and an abutment connection 10003. The load connection 10002, together with a housing part 10005, forms a cover section 10004, comprises a threaded bore 10006 and carries a spring element 10007. As also in the case of the solid bearing from FIG. 4, according to FIG. 5 the load connection 10002 also does not extend through the complete spring element 10007. The spring element 10007 exhibits a specific geometry and thus spring characterizing line and, together with a nozzle disc 10009, comprises a load-side damper chamber 10012 in the form of a dynamic air chamber. The damper chamber 10012 furthermore represents a pneumatic spring. Given correspondingly thin dimensioning of a web 10007a of the spring element 10007, the spring characteristic of the spring element 10007 is namely substantially caused by the geometry of the chamber 10012 and only secondarily by the elastomer of the spring element 10007. In the nozzle disc 10009, a throttling port 10010 is provided that serves to connect the dynamic air chamber 10012 with a static air chamber 10013, meaning a chamber with a substantially unchanging volume. The static air chamber 10013 is bounded by the nozzle disc 10009 as well as the floor section. The floor section for its part comprises an air connection 10011, such that the air chamber 10013 can be charged with a control air in order to be able to adjust such specially desired bearing properties, in particular via a change of the pressure relationships in the air chambers 10012, 10013. Additionally, a supplementary chamber 10016 can be alternatively coupled in parallel by opening a throttling port 100015 in an interchangeable cushioning disc 10014 of the floor section.

The measurements of the throttling ports 10010 and 10015 with which the damping and bearing characteristics are determined are selected via selection of a suitable nozzle disc 10009 or, respectively, cushioning disc 10014. For this, the throttling ports 10010 and 10015, as well as a valve (not shown) can be adjusted (meaning they can be closed or, respectively, opened) in the air connection dependent on the desired damping and/or bearing characteristics. For this purpose, a sensor (not shown) to detect the air column is provided in the air chambers 10012, 10013 and 10016 in effective connection with a control and/or regulation unit (not shown). This further enables the determination of a vibration frequency.

The modular bearing system shown in FIG. 5 is varied, for example, in that the cushioning disc 10014 is done away with and thus only a static bearing chamber is present, or in addition to the supplementary air chamber 10016 or, respectively, in place of it at least one external (meaning spatially separate from the bearing system) static air chamber is provided that is in effective connection with the chambers 10013 and/or 10016.

The inventive modular bearing system offers the possibility to be able to substantially, arbitrarily adjust the frequency, damping and/or amplitude behavior of the overall bearing system. Schematically shown in FIG. 6 is the amplitude relationship, i.e. the relationship of the amplitude of the load and the amplitude of the excitation for various frequencies. The graph I thereby reproduces the frequency curve of the amplitude relationship for an subcritical adaptation of the inventive bearing system, and the graph II reproduces the curve of the amplitude relationship for a supercritical adjusted inventive bearing system. An exemplary eigenfrequency range of a load (for example an aggregate), is indicated with III.

When, for example, a motor vehicle drives over an uneven street at 120 km/h, or alternating load shocks effect an aggregate of the motor vehicle, the range of the excited frequencies thus lies (among other things) between 8 and 16 Hz for the bearing of the aggregate. Moreover, in a motor vehicle a plurality of further excitation frequency bands are present, in particular caused by aggregate vibrations (meaning, for example, motor noise) that exhibit a higher frequency but a lower amplitude. To simplify matters, these are not shown in FIG. 6.

As is to be learned from FIG. 6, the eigenfrequency or, respectively, resonance frequency of a subcritical adjusted bearing system is below the frequency range III, while the resonance frequency of a supercritical adjusted bearing system is above the frequency range III. A subcritical adjustment of the bearing system leads to a very good isolation behavior, however also to a relatively weak spring characteristic, while in contrast given a supercritical adjustment a harder springiness ensues that, for example, are [sic] suitable for damping of the specified excitations for a motor vehicle passenger on an uneven street.

The inventive bearing system now offers a plurality of possibilities to undertake an adaptation of the bearing system, meaning an amplitude, damping, and/or frequency tuning. A subcritical adjustment is thus in particular to be achieved in that the air column is varied in the different chambers. This is preferably achieved in that the air volume is varied by changing the connection openings between the different chambers or, respectively, (in particular temporarily) connecting an air volume. Furthermore, such an adjustment can also be achieved in that the static air pressure within the different chambers is varied. This is preferably achieved via a valve according to the valve in the air connection 10011.

Naturally, a plurality of further modulations of the specified components of the inventive modular bearing system is imaginable. In particular, the inventive bearing system is in no way limited to the use of a solid bearing coupled in parallel with an air damper and/or air bearing.

The features of the invention disclosed in the previous specification, in the drawings, and the claims can be substantial both individually and in every arbitrary combination for the realization in their various embodiments.

Reference list

| | |
|---|---|
| 1 | solid bearing |
| 2 | load connection |
| 3 | abutment connection |
| 4 | cover section |
| 5 | skirt |
| 6 | threaded bore |
| 7 | toroidal core spring |
| 8 | damper housing |
| 9 | collar |
| 10 | housing part |
| 11 | threaded boring |
| 12 | connection boring |
| 13 | roll membrane |
| 14 | membrane plate |
| 15 | attachment screw |
| 16 | connection section |
| 17 | load-side damper chamber |
| 18 | abutment-side damper chamber |
| 19, 19′ | sidewall |
| 20, 20′ | floor wall |
| 21 | side wall |
| 22 | cover wall |
| 23 | housing opening |
| 24 | throttling port |
| 25 | foam material layer |
| 101 | solid bearing |
| 102 | load connection |
| 103 | abutment connection |
| 104 | cover section |
| 105 | skirt |
| 106 | threaded bore |
| 107 | toroidal core spring |
| 108 | chassis carrier |
| 109 | upper carrier web |
| 110 | lower carrier web |
| 111 | load-side depression |
| 112 | abutment-side depression |
| 113 | pass-through opening |
| 114 | air damper |
| 115 | connection section |
| 116 | membrane plate |
| 117 | attachment screw |
| 118 | roll membrane |
| 119 | covering cap |
| 120 | threaded bore |
| 121 | load-side damper chamber |
| 122 | abutment-side damper chamber |
| 123 | chassis counter plate |
| 124 | side wall |
| 125 | cap counter plate |
| 126 | throttling port |
| 127 | foam material layer |
| 1001 | solid bearing |
| 1002 | load connection |
| 1003 | abutment connection |
| 1004 | cover section |
| 1005 | housing part |
| 1006 | threaded bore |
| 1007 | cone spring |
| 1007a | spring strut |
| 1007b | spring projection |
| 1007c | spring projection |
| 1008 | flange |
| 1009 | nozzle disc |
| 1010 | throttling port |
| 1011 | depression |
| 1012 | load-side damper chamber |
| 10001 | solid bearing |
| 10002 | load connection |
| 10003 | abutment connection |
| 10004 | cover section |
| 10005 | housing part |
| 10006 | threaded bore |
| 10007 | spring element |
| 10007a | web |
| 10008 | floor section |
| 10009 | nozzle disc |
| 10010 | throttling port |
| 10011 | air connection |
| 10012 | dynamic air chamber |
| 10013 | static air chamber |
| 10014 | cushioning disc |
| 10015 | throttling port |
| 10016 | supplementary air chamber |
| I | graph |
| II | graph |
| III | frequency range |

1. Modular bearing system (1, 101, 1001, 10001) with a load-side cover section (4, 5, 6, 16, 104, 105, 106, 115, 1004, 1005, 1006, 10005, 10005, 10006) and an abutment-side floor section (8, 9, 10, 11, 12, 19, 19′, 20, 20′21, 22, 108, 109, 110, 111, 112, 119, 123, 124, 125, 1003, 1008, 10003, 10008, 10014), whereby at least two functional units (7, 17, 18, 107, 121, 122, 1007, 1012, 10007, 10012, 10013, 10016) selected from a plurality of functional units (comprising at least one rubber-metal bearing element, an air bearing element (10013, 10016), a hydraulic bearing element, a solid bearing element, a spring, a spring element (10007), a toroidal core spring (7, 107), a cone spring (1007), a pneumatic spring (10012), a damper and/or an air damper(17, 18, 24, 121, 122, 126, 1010, 1012, 10010, 10012, 10015) to damp and/or bear a load to be supported by the cover section—in particular in the form of an aggregate or undercarriage of a motor vehicle—relative to a carrier (108) carrying the floor section, in particular in the form of a chassis or car body structure of a motor vehicle, with adjusted and/or adjustable frequency, damping and/or amplitude in parallel coupling) can be detachably affixed between the cover section and the floor section.

2. Modular bearing system according to claim 1, characterized in that the cover section and/or the floor section (108, 109, 110, 111, 112, 119, 123, 124, 125) is or, respectively, are comprised at least in sections by the load and/or the carrier (108, 109, 110, 111, 112, 123, 124), whereby preferably the floor section is comprised at least in sections by the carrier.

3. Modular bearing system according to claim 2, characterized in that the load and/or the carrier comprises or, respectively, comprise a hollow section, in particular in the form of two half-shells (109, 110), whereby preferably the upper half-shell (109) serves to accept at least one functional unit (107) and the lower half-shell (110) serves to accept at least one further functional unit (121), in particular the half-shells (109, 110) comprise a central bore in which the central bolt can be introduced to detachable affix the functional units (107, 121, 122).

4. Modular bearing system according to any of the preceding claims, characterized in that
at least one part of the cover section and/or at least one part of the floor section is interchangeably fashioned in adaptation to the number and/or the type of the selected functional units and/or the adjusted and/or adjustable frequency, damping, and/or amplitude.

5. Modular bearing system according to any of the preceding claims, characterized by
at least one supplementary functional unit (10016) that can be arranged between the cover section (10004, 10005, 10006) and the floor section (10003, 10008) or outside of the cover section and the floor section, and alternatively can be connected to the at least two functional units (10007, 10012, 10013) between the cover section (10004, 10005, 10006) and the floor section (10003, 10008).

6. Modular bearing system according to any of the preceding claims, characterized by
at least one sensor to detect a damping or bearing characteristic.

7. Modular bearing system according to any of the preceding claims, characterized by
a control and/or regulation unit in effective connection with the functional units, the supplementary functional unit, the sensor, the load and/or the carrier.

8. Modular bearing system according to any of the preceding claims, characterized by
a toroidal core spring (7, 107), cone spring (1007) and/or a spring element (10007), preferable fashioned from an elastomer and comprising internally in their cavities and/or channels as a first functional unit (in particular arranged on the load side) at least one air damper (17, 18, 24, 121, 122, 126, 1010, 1012, 10010, 10012, 10015) as two functional units arranged in particular on the abutment side.

9. Modular bearing system according to claim 8, characterized in that the air damper comprises at least one damper chamber (17, 18, 121, 122, 1012, 10012), in particular dynamic air chamber, that is bordered on the load side by the toroidal core spring (7, 107), the cone spring (1007) and/or the spring element (10007), either directly or via a part of the cover section and/or floor section.

10. Modular bearing system according to claim 8 or 9, characterized in that the air damper substantially introduces no operatively effective spring components into the bearing characteristic line of the toroidal core spring.

11. Modular bearing system according to any of the claims 8 through 10, characterized in that
the air damper (17, 18, 24, 121, 122, 126) comprises an axial movable membrane plate (14, 116) (firmly connected with at least one part (16, 115) of the cover section (4, 5, 6, 16, 104, 105, 106, 115)) in which at least one throttling port (24, 126) open on both sides is provided, and at least one damper chamber (17, 18, 121, 122) that is bounded at least partially by a membrane (13, 118) (in particular roll membrane) firmly connected with the membrane plate (14, 116) and/or by the membrane plate itself, whereby the membrane plate (14, 116) is aligned coplanar to an axially opposite counter plate (20, 22, 123, 125) of the floor section (8, 9, 10, 11, 12, 19, 19′, 20,20′, 21, 22, 108, 109, 110, 111, 112, 119, 123, 124, 125).

12. Modular bearing system according to claim 11, characterized in that the air damper comprises a damper chamber (17) arranged on the load side with regard to the membrane plate (14).

13. Modular bearing system according to claim 12, characterized in that the floor section (8, 9, 10, 11, 12, 19, 20, 21, 22) comprises an attachment part (11, 19) that is attached to the carrier (8) to jam the membrane (13) and comprises a fittingly dimensioned recess for unhindered passing of the membrane plate (14).

14. Modular bearing system according to claim 11, characterized in that the air damper comprises two damper chambers (17, 18, 121, 122), whereby one load-side damper chamber (17, 121) is bounded by an abutment-side damper chamber (18, 122) via the membrane plate (14, 116) and the membrane (13, 118) connected with this.

15. Modular bearing system according to claim 14, characterized in that the floor section (108, 109, 110, 111, 112, 119, 123, 124, 125) comprises a covering cap (110) (preferably detachable connectable with the carrier (108), in particular fashioned shaped like a cup), and the abutment-side damper chamber (122) is bounded by the covering cap (119), whereby preferably each damper chamber (121, 122) is sealed by circumferential jamming of the membrane (118) connected with the membrane plate (116) between the carrier (108) and the covering cap (119).

16. Modular bearing system according to any of the claims 11 through 15, characterized in that the membrane plate (14, 116) is detachably connectable (in particular via screwing) with the cover section and/or floor section (8, 108).

17. Modular bearing system according to claim 9, characterized by a nozzle disc (1009, 10009), with at least one throttling port (1010, 10010), by which the damper chamber (1012, 10012) is bounded, whereby the nozzle disc (1009, 10009) is preferably detachable connectable with the cover section and/or floor section (1005, 10005, 10008).

18. Modular bearing system according to claim 17, characterized in that the cone spring (1007) comprises at least one abutment-side spring projection (1007c), and the nozzle disc (1009) comprises at least one load-side depression (1011) complementary to the spring projection (1007c), in particular in the region of the throttling bore (1010).

19. Modular bearing system according to any claims 9 through 18, characterized by
foam material (25, 127) in at least one damper chamber (17, 18, 121, 122), preferably in the form of a foam material layer on the membrane plate (14, 116) and/or the counter plate (20) and/or the covering cap (119) or the nozzle disc.

20. Modular bearing system according to any of the preceding claims 8 through 19, characterized by
at least one air bearing (10013, 10016) as a third functional unit on the abutment-side of the air damper (10012).

21. Modular bearing system according to claim 20, characterized in that the air bearing comprises at least one static bearing chamber (10013, 10016) that is preferably bounded on the abutment-side by the nozzle disc (10009).

22. Modular bearing system according to claim 21, characterized by at least one cushioning disc (10014) with at least one throttling port (10015), via which two bearing chambers (10013, 10016) are separated from one another, whereby the cushioning disc (10014) is preferably detachably connectable with the floor section (10008) or is firmly integrated into the floor section.

23. Modular bearing system according to any of the claims 20 through 22, characterized by
an air connection (10011) (in particular with a valve) to a bearing chamber (10013), whereby the air connection (10011) is preferably integrated into an interchangeable part of the floor section (10008).

24. Modular bearing system according to any of the claims 6 through 23, characterized by
a first sensor to detect the height of the air column in an air damper and/or air bearing and/or
a second sensor to detect the pressure in an air damper and/or air bearing, whereby the first and/or second sensor is or, respectively, are preferably effectively connected with the control and/or regulation unit.

25. Modular bearing system according to any of the claims 11 through 24, characterized in that
at least one throttling port is (preferably continuously) variable or, respectively, adjustable via the control and/or regulation unit.

26. Modular bearing system according to any of the preceding claims, characterized in that
the separation between the load and the carrier is adjustable, in particular via the control and/or regulation unit, preferably via at least one element of the cover section and/or floor section that can be telescoped, inflated, swung out, rotated out and/or extended.

27. Modular bearing system according to any of the preceding claims, characterized in that
modules of the bearing system, in particular at least one part of the cover section, at least one part of the floor section, and at least one part of each functional unit, comprises or, respectively, comprise at least one marking to facilitate an assembly.

28. Modular bearing system according to claim 27, characterized in that the marking can be taken from a target use purpose.

29. Use of the modular bearing system according to any of the preceding claims in vehicle technology, in particular motor vehicle technology, in particular for bearing of aggregates such as an internal combustion engine and/or a wheel suspension.

30. Method to adjust the amplitude, damping, and/or frequency behavior of a modular bearing system, in particular according to one of the preceding claims, characterized by the following steps:
determination of the desired amplitude, damping, and/or frequency behavior of the modular bearing system;
selection of at least four modules, in particular in the form of a load-side cover section, an abutment-side floor section, and two functional units (in particular that can be detachably affixed coupled in parallel between the cover section and the floor section) such as a rubber-metal bearing element, an air bearing element, a hydraulic bearing element, a solid bearing element, a spring, a spring element, a toroidal core spring, a cone spring, an air spring, a damper and/or an air damper with adjusted and/or adjustable damping, frequency and/or amplitude;
assembly of the module, in particular by means of at least one screw connection, riveted connection, welded connection and/or adhesive connection.

31. Method according to claim 30, characterized in that the selection is facilitated by means of a marking, in particular for identification of a target use purpose and/or the adjusted damping, frequency and/or amplitude that is exhibited by the modules.

32. Method according to claim 30 or 31, characterized by the additional adjustment and/or adaptation of the damping, frequency and/or amplitude of at least one module, in particular during the operation of the bearing system.

33. Method according to claim 32, characterized in that the adjustment and/or adaptation of the damping, frequency and/or amplitude of the module comprises
the adjustment, in particular of the geometry and/or of at least one flow-through property, at least one throttling port between two air chambers (preferably comprised by an air damper and/or a pneumatic spring),
the adjustment, preferably by means of a valve, of an air pressure within at least one air chamber, and/or
the adjustment of the volume of at least one air chamber, preferably by means of a linked the air chamber [sic] with a further air volume, in particular by means of a valve arranged between the air chamber and the air volume and/or an adjustment of the geometry of the air chamber,
preferably by means of a control and/or regulation unit and/or dependent on at least one measurement value provided by a sensor (preferably effectively connected to the control and/or regulation unit), such as an air column, a load property (preferably the weight of the load), a vibration frequency and/or a pressure.

34. Method according to any of the claims 30 through 33, characterized in that at least one module from the bearing system is removed and/or exchanged to adjust the damping, frequency and/or amplitude behavior.
